(19) United States
(12) Patent Application Publication
(10) Pub. No.: US 2001/0002088 A1
(43) Pub. Date: May 31, 2001

(54) SECURITY PACKAGE AND METHOD FOR MAKING SAME

(76) Inventor: RONALD F. DE SANTO, PALOS HILLS, IL (US)

Correspondence Address: TREXLER BUSHNELL, GIANGIORGI & BLACKSTONE LTD, 105 W ADAMS STREET, CHICAGO, IL, 60603

(21) Appl. No.: 09/348,925

(22) Filed: Jul. 6, 1999

(51) Int. Cl. B42D 15/00

(52) U.S. Cl. 283/67

(57) ABSTRACT

A security package for receiving information and keeping the information concealed until an intended recipient of the security package opens the package to gain access to the information. The security package includes a form that provides at least one area which is designated for receiving the information. The form includes at least one fold line dividing the form into at least two panels. The area designated for receiving the information is on at least one of the panels. Each of the panels is defined by the fold line, a distal edge generally parallel to the fold line and two generally parallel transverse edges extending between the fold line and the distal edge. Retackable glue is provided on at least one of the panels, and is located generally proximate to each of the generally parallel transverse edges thereof. Securing means is located generally proximate to the distal edge of at least one of the panels. The form is foldable along the fold line to mate the two panels such that the retackable glue on at least one of the panels mates with the other panel. Additionally, the sealing means acts to generally mate at least one of the distal edges of the panels to the other panel, thereby generally providing a bond between the panels which generally secures the concealed information by providing that the information cannot generally be accessed without an appearance of the package providing proof of tampering. A method for making such a security package is also provided.

### BACKGROUND

The present invention generally relates to security packages, such as to credit card applications which are designed to receive information and thereafter be manipulated to conceal the information until the package is received by an intended recipient. The invention more specifically relates to a security package which is configured to receive information and thereafter be manipulated to conceal the information until the package is received by an intended recipient, where the concealed information is kept generally secure and cannot generally be accessed without an appearance of the package providing proof of tampering.

It is common for a credit card company to mail out or otherwise distribute applications to people, such as to people who appear on a mailing list which has been purchased by the credit card company. The applications typically include areas which are designated to receive information about the applicant, where some of the information is relatively personal and important to keep confidential. Such information may include the applicant's social security number, the applicant's mother's maiden name, etc. Typically, the application provides that it can be manipulated after the application is filled out, such that the information which has been entered thereon is generally concealed before the application is deposited in the mail.

While the typical credit card application which is designed to be mailed back to the credit card company after the application has been completed by an applicant does provide that the form can be manipulated to generally conceal the information before the application is deposited in the mail, the typical application provides that it is relatively easy to manipulate the package to view the concealed information. Additionally, the typical credit card application does not provide that such a manipulation results in the package having an appearance which evidences tampering. Subsequently, the person who has obtained the applicant's confidential information can use the information to commit fraud, such as to apply for additional credit cards in that person's name.

Unfortunately, fraud is a significant problem in the credit card industry. Therefore, it is desirable to take steps to try to prevent fraud, such as by providing that it is more difficult for someone to manipulate a security package, such as a credit card application, to gain access to another person's confidential information.

### OBJECTS OF THE INVENTION AND SUMMARY OF THE DISCLOSURE

A general object of an embodiment of the present invention is to provide a security package which conceals information and keeps the information generally secure until the package is received by an intended recipient. Another object of an embodiment of the present invention is to provide a method for making such a security package.

Still another object of an embodiment of the present invention is to provide a security package which keeps concealed information generally secure until the package is received by an intended recipient, and provides that the information cannot generally be accessed without an appearance of the package providing proof of tampering. Still yet another object of an embodiment of the present invention is to provide a method for making such a security package.

Briefly, and in accordance with at least one of the foregoing, an embodiment of the present invention provides a security package for receiving information and keeping the information concealed until an intended recipient of the security package opens the package to gain access to the information. The security package includes a form that provides at least one area which is designated for receiving the information. The form includes at least one fold line dividing the form into at least two panels. The area designated for receiving the information is located on at least one of the panels. Each of the panels is defined by the fold line, a distal edge generally parallel to the fold line and two generally parallel transverse edges extending between the fold line and the distal edge. Retackable glue is provided on at least one of the panels, and is located generally proximate to each of the generally parallel transverse edges. Securing means is located generally proximate to the distal edge of at least one of the panels. The form is foldable along the fold line to mate the two panels such that the retackable glue on at least one of the panels mates with the other panel. Additionally, the sealing means acts to generally mate at least one of the distal edges of the panels with the other panel, thereby generally providing a bond between the panels which generally secures the concealed information by providing that the information cannot generally be accessed without an appearance of the package providing proof of tampering.

Preferably, the securing means comprises remoist glue on the distal edge of at least one of the panels, and the retackable glue is generally proximate the area which is designated for receiving the information. One of the panels may include an additional fold line, thereby defining a subpanel, and the securing means may be located on the subpanel. The retackable glue may be provided generally proximate to the generally parallel transverse edges of both of the panels. The form may consist of a credit card application which includes an area designated to receive a social security number and an area designated to receive a mother's maiden name.

Another embodiment of the present invention provides a method for making a security package for receiving information and keeping the information concealed until an intended recipient of the security package opens the security package to gain access to the information. The method includes steps of printing on paper to define a form, where the form includes at least one area designated for receiving the information, providing securing means on the paper, applying retackable glue to the paper and folding the paper to form at least one fold line, where the fold line divides the form into at least two panels and the area designated for receiving the information is located on at least one of the panels. Each of the panels is defined by the fold line, a distal edge which is generally parallel to the fold line and two generally parallel transverse edges which extend between the fold line and the distal edge. The retackable glue is on at least one of the panels, located generally proximate to each of the generally parallel transverse edges, and providing securing means on the paper. The securing means is preferably located generally proximate to at least one of the distal edges of the panels, and the form is preferably foldable along the fold line to mate the panels such that the retackable glue on at least one of the panels mates with the other panel, and the securing means acts to generally mate a distal edge of at least one of the panels with the other panel, thereby generally providing a bond between the panels which generally secures the concealed information by providing that the information cannot generally be accessed without an appearance of the package providing proof of tampering.

### BRIEF DESCRIPTION OF THE DRAWINGS

The organization and manner of the structure and function of the invention, together with further objects and advantages thereof, may be understood by reference to the following description taken in connection with the accompanying drawings, wherein like reference numerals identify like elements, and in which:

FIG. 1 is a top, plan view of a security package which is in accordance with a first embodiment of the present invention, showing the security package before it is folded;

FIG. 2 is a top, plan view of the security package illustrated in FIG. 1, showing the security package after it has been folded;

FIG. 3 is a top, plan view of a security package which is in accordance with a second embodiment of the present invention, showing the security package before it is folded;

FIG. 4 is a block diagram of a method which may be employed to make the security packages illustrated in FIGS. 1-3.

### DESCRIPTION

While the present invention may be susceptible to embodiment in different forms, there is shown in the drawings, and herein will be described in detail, certain embodiments with the understanding that the present description is to be considered an exemplification of the principles of the invention and is not intended to limit the invention to that as illustrated and described herein.

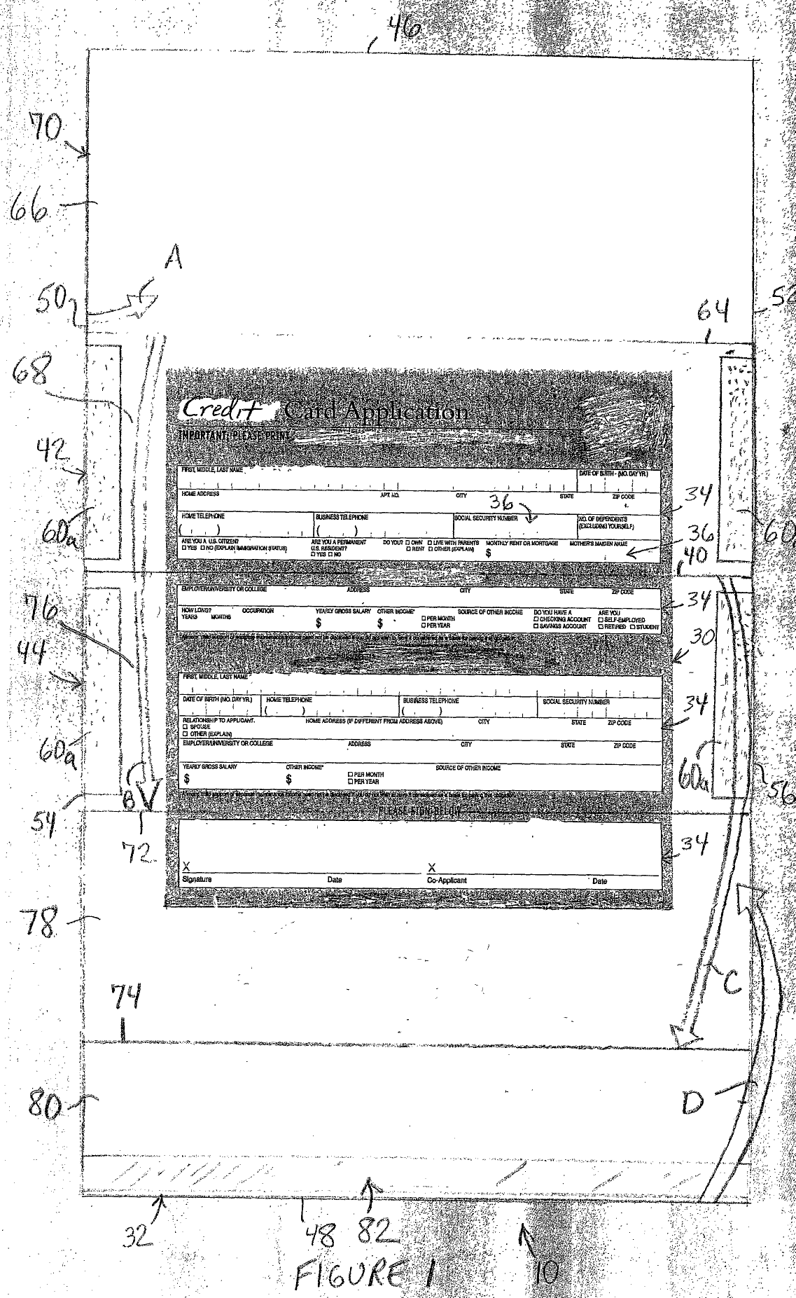

The drawings illustrate two different security packages 10 and 20, each of which is in accordance with an embodiment of the present invention. Specifically, FIGS. 1 and 2 illustrate a security package 10 which is in accordance with a first embodiment of the present invention, and FIG. 3 illustrates a security package 20 which is in accordance with a second embodiment of the present invention. Both security packages 10 and 20 are configured to receive information and then be manipulated to conceal the information. Specifically, both security packages 10 and 20 are configured to keep the concealed information generally secure until an intended recipient of the security package opens the package.

Since the two security packages 10 and 20 are identical to each other in many aspects, identical reference numerals are used to identify identical parts and, at times, a detailed description of a part is omitted with the understanding that one may review a previous description thereof.

As discussed, FIGS. 1 and 2 illustrate a security package 10 which is in accordance with a first embodiment of the present invention. Specifically, FIG. 1 illustrates the security package 10 before the package is folded, and FIG. 2 illustrates the security package 10 after the package is folded. The security package 10 preferably consists of a foldable form 30, such as a credit card application, which is disposed on a sheet 32 of paper. Preferably, the form 30 includes areas 34 for receiving information, such as areas in which a credit card applicant may provide information. At least one area 36 may be designated for receiving sensitive information, such as relatively personal information about a credit card applicant. Such areas 36 may include an area for receiving a credit card applicant's social security number, and an area for receiving an applicant's mother's maiden name, as well as other areas for receiving confidential information about the applicant.

The package 10 includes a fold line 40 which divides the package 10 into two panels, a first panel 42 and a second panel 44. Specifically, each panel 42 and 44 is defined by the fold line 40, a distal edge 46, 48 generally parallel to the fold line 40, and two generally parallel transverse edges 50, 52 and 54, 56 which extend between the fold line 40 and the distal edge 46, 48.

Retackable glue 60a is provided on at least one of the first and second panels 42 and 44, respectively, located generally proximate to each of the generally parallel transverse edges 50, 52 and 54, 56. Preferably, retackable glue 60a is provided on both the first and second panels 42 and 44, respectively, at least generally proximate the areas 36 of the form 30 in which sensitive information is to be entered. As will be described, the retackable glue 60a provides that the first and second panels 42 and 44, respectively, mate upon the package 10 being folded along the fold line 40, thereby generally concealing and securing the information which has been entered on the form 30.

Either one or both or the first and second panels 42 and 44, respectively, may include one or more additional fold lines which define one or more sub-panels. For example, as shown in FIG. 1, preferably the first panel 42 includes a fold line 64 which defines two sub-panels 66 and 68. As shown, the form 30 may be provided on one of the sub-panels 68 while the other sub-panel 66 defines a tear-away portion 70 of the package 10. To facilitate the tearing away of the sub-panel 66, preferably the fold line 64 between the two sub-panels 66 and 68 is perforated.

Preferably, the second panel 44 includes two fold lines 72 and 74 thereby defining three sub-panels 76, 78 and 80. As shown, the form 30 may be located on two of the three sub-panels 76 and 78 with the third sub-panel 80 having securing means 82, such as a strip of remoist glue or an adhesive strip having a tear away cover strip, generally proximate to distal edge 48 for securing the package 10 after it has been folded, which will be described in detail hereinbelow.

Preferably, the package 10 is configured such that, after information is entered on the form 30, the package 10 can be manipulated to conceal and secure the information until an intended recipient, such as a credit card company, receives the package 10. This manipulation of the package 10 to provide the desired concealment and securement will now be described.

As mentioned, the first panel 42 may include a tear-away sub-panel 66. If this is the case, then preferably the user, such as a credit card applicant, either before or after filling out the form 30, tears away the sub-panel 66 along the fold line 64. This step is represented in FIG. 1 by arrow A. Then, if the securing means 82 consists of, for example, a remoist glue strip, the user licks the remoist glue strip. On the other hand, if the securing means 82 consists of an adhesive strip with a tear-away cover strip, then the user tears away the cover strip to expose the adhesive strip.

Subsequently, the user folds the package 10 along the fold line 40 such that the first panel 42 generally mates with the second panel 44. This step is represented in FIG. 1 by arrow B. Preferably, the mating between the panels 42 and 44 causes the retackable glue 60a on at least one of the first and second panels 42 and 44, respectively, to mate with the other panel thereby generally providing a bond between the first and second panels 42 and 44, respectively. As mentioned hereinabove, preferably both the first and second panels 42 and 44, respectively, have retackable glue 60a thereon. Additionally, preferably, the retackable glue 60a is disposed on the panels 42 and 44 such that folding the first and second panels 42 and 44, respectively, causes the retackable glue 60a on the first panel 42 to mate with the retackable glue 60a on the second panel 44. However, it is possible to provide retackable glue 60a on only one of the first and second panels 42 and 44, respectively. In such case, when the package 10 is folded along fold line 40, the retackable glue 60a on the one panel (42 or 44) mates with the non-glued surface of the other panel (44 or 42, respectively).

After the user folds the package 10 along the fold line 40 to mate the first and second panels 42 and 44, respectively, if the additional fold lines are provided, the user continues to fold the form along the fold lines, such as along fold line 72 (as represented by arrow C in FIG. 1) and then along fold line 74 (as represented by arrow D in FIG. 1), thereby causing the securing means 82 to mate with the back of the second panel 44 (see FIG. 2), thereby fully securing the package 10, and particularly fully concealing and securing the information which has been entered on the form 30. After the package 10 is completely folded, as shown in FIG. 2, the information therein is concealed and secured due to the mating of the first and second panels 42 and 44 as provided by the retackable glue 60a on one or both of the panels 42 and 44, and due to the securement provided by the securing means 82. Preferably, the concealed and secured information cannot generally be accessed without altering the appearance of the package 10. In other words, the information cannot be accessed without one deforming or otherwise altering the appearance of the sides of the package 10 or the portion 90 of the form 30 which has the bond effected by the securement means 82, as shown in FIG. 2.

The package 10 provides that when an intended recipient, such as a credit card company, receives the package 10, the package 10 can be opened by cutting generally along fold line 74 and the two sides 50, 54 and 52, 56. Subsequently, the form 30 can be opened.

FIG. 3 illustrates a security package 20 which is in accordance with a second embodiment of the present invention. FIG. 3 illustrates the security package 20 before the package is manipulated to secure information which has been entered on the form 30. The method of securing the package 20 is effectively the same as was described above in connection with the security package 10 shown in FIGS. 1 and 2. Additionally, the appearance of the security package 20 after the package 20 is folded is the same as shown in FIG. 2. In fact, the security package 20 shown in FIG. 3 is preferably identical to the security package 10 shown in FIGS. 1 and 2, except the retackable glue 60b is provided along more of a length of the generally parallel transverse edges 50, 52 and 54, 56 of the first and second panels 42 and 44, respectively. By providing that the retackable glue 60a is disposed generally along more of the lengths of the generally parallel transverse edges 50, 52 and 54, 56 of the first and second panels 42 and 44, respectively, the information entered on the form 30 can be better secured in that there results less areas between the transverse edges 50, 52 and 54, 56 of the first and second panels 42 and 44, respectively, where there is no mating.

As mentioned, fraud is a major concern in many industries, such as in the credit card industry. Both security packages 10 and 20 described above provide that information can be entered on a form 30, and then the package 10, 20 can be manipulated to provide that the information entered on the form 30 becomes concealed and secured such that the information cannot generally be accessed without providing proof of tampering.

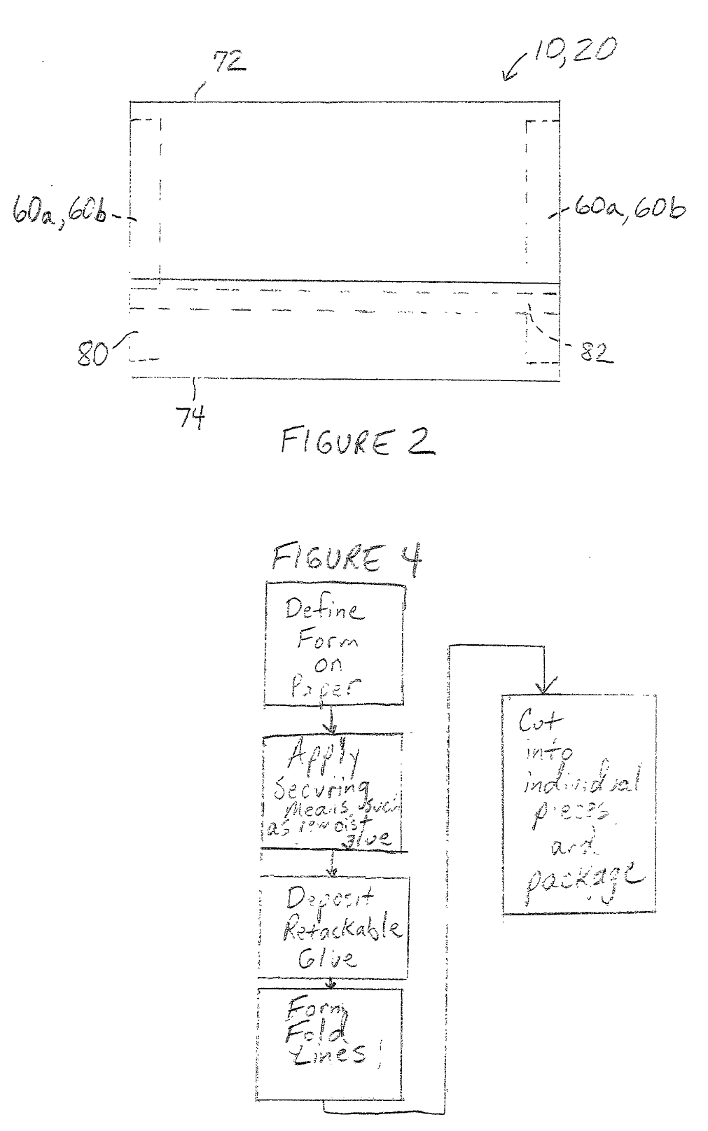

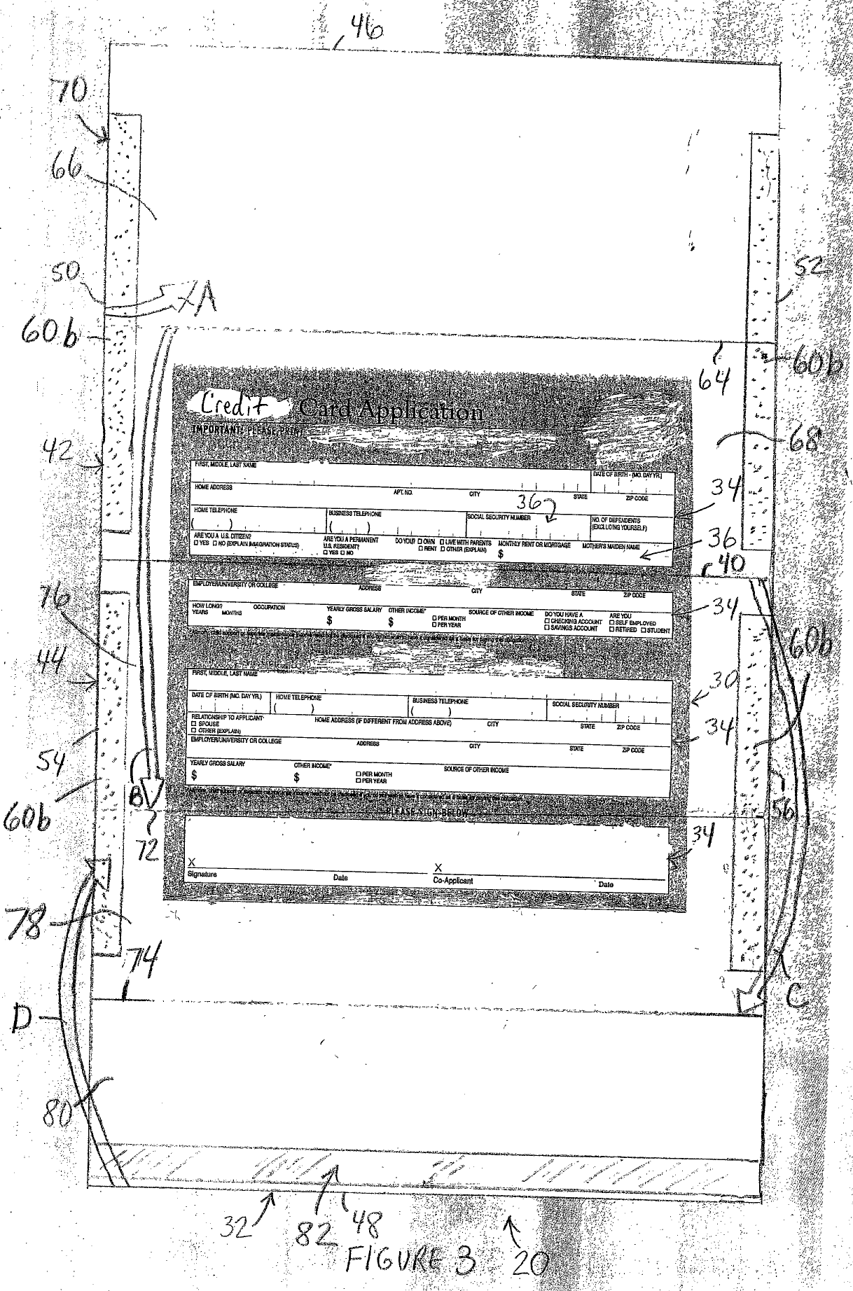

Either package 10 or 20 may be made using the following process which is described with reference to FIG. 4. First, ink is deposited on paper on an offset press to define the form 30. Then, the securing means 82, such as remoist glue, is applied using a pattern gluer and the paper is then dried in an oven and cooled on chill rolls before going into an inline process. Subsequently, the retackable glue 60a is applied to panel 42 using a seam glue unit. Then, the web of paper proceeds through a series of plow folding stations whereby fold lines 40, 64, 72, 74 are formed and causing panel 42 to mate with panel 44. The mating causes the retackable glue 60 a on panel 42 to contact panel 44, thereby providing retackable glue 60b on panel 44. The folded ribbon then goes into a rotary cutter where it is cut into individual pieces (packages 10, 20) and packaged.

While embodiments of the present invention are shown and described, it is envisioned that those skilled in the art may devise various modifications and equivalents without departing from the spirit and scope of the invention as defined by the appended claims. The invention is not intended to be limited by the foregoing disclosure.

What is claimed is:

1. A security package for receiving information and keeping the information concealed until an intended recipient of the security package opens the security package to gain access to the information, said security package comprising:
a form including at least one area designated for receiving the information, said form having at least one fold line dividing said form into at least two panels, a first panel and a second panel, said area being on at least one of said first and second panels, each of said first and second panels defined by said fold line, a distal edge generally parallel to said fold line, and two generally parallel transverse edges extending between said fold line and said distal edge;
retackable glue on at least one of said first and second panels, located generally proximate to each of the generally parallel transverse edges; and
securing means located generally proximate to at least one of the distal edges of the first and second panels, said form being foldable along the fold line to mate the first and second panels such that said retackable glue on at least one of said first and second panels mates with the other of said first and second panels and the sealing means acts to generally mate at least one of the distal edges of the first and second panels with the other of said first and second panels, thereby generally providing a bond between the first and second panels which generally secures the concealed information by providing that said information cannot generally be accessed without an appearance of the package providing proof of tampering.

2. A security package according to claim 1, wherein said securing means comprises remoist glue on the distal edge of at least one of said first and second panels.

3. A security package according to claim 1, wherein said retackable glue is generally proximate to said area designated for receiving the information.

4. A security package according to claim 1, wherein at least one of said first and second panels includes an additional fold line between said fold line and said distal edge, thereby defining a subpanel.

5. A security package according to claim 4, wherein said securing means is located on said subpanel.

6. A security package according to claim 1, wherein said retackable glue is generally proximate each generally parallel transverse edge of both the first and second panels.

7. A security package according to claim 1, wherein said form comprises a credit card application.

8. A security package according to claim 1, wherein said area includes an area designated to receive a social security number.

9. A security package according to claim 1, wherein said area includes an area designated to receive a mother's maiden name.

10. A security package for receiving information and keeping the information concealed until an intended recipient of the security package opens the security package to gain access to the information, said security package comprising:
a form including at least one area designated for receiving the information, said form having at least two fold lines, a first fold line and a second fold line, dividing said form into at least three panels, a first panel, a second panel and a third panel, said area being on at least one of said first, second and third panels, said first panel being defined by said first fold line, a first distal edge generally parallel to said first fold line, and two generally parallel transverse edges extending between said first fold line and said first distal edge, said second panel being defined by said first fold line, said second fold line, and two generally parallel transverse edges extending between said first fold line and said second fold line, said third panel being defined by said second fold line, a second distal edge generally parallel to said second fold line and two generally parallel transverse edges extending between said second fold line and said second distal edge,
retackable glue on at least one of said first, second and third panels, located generally proximate to each of the generally parallel transverse edges thereof; and
securing means located generally proximate to at least one of the first and second distal edges, said form being foldable along at least one of the first and second fold lines such that said retackable glue on at least one of said first, second and third panels mates with at least one other of said first, second and third panels and the sealing means acts to generally mate at least one of the first and second distal edges with at least one of the first and second panels, thereby generally providing a bond which generally secures the concealed information by providing that said information cannot generally be accessed without an appearance of the package providing proof of tampering.

11. A security package according to claim 10, wherein said securing means comprises remoist glue generally proximate to at least one of the first and second distal edges.

12. A security package according to claim 10, wherein said retackable glue is generally proximate to said area designated for receiving the information.

13. A security package according to claim 10, wherein at least one of said first and third panels includes an additional fold line thereby defining a subpanel.

14. A security package according to claim 13, wherein said securing means is located on said subpanel.

15. A security package according to claim 10, wherein said retackable glue is generally proximate each generally parallel transverse edge of all three of said first, second and third panels.

16. A security package according to claim 10, wherein said form comprises a credit card application.

17. A security package according to claim 10, wherein said area includes an area designated to receive a social security number.

18. A security package according to claim 10, wherein said area includes an area designated to receive a mother's maiden name.

19. A method for making a security package for receiving information and keeping the information concealed until an intended recipient of the security package opens the security package to gain access to the information, said method comprising:
printing on paper to define a form, said form including at least one area designated for receiving the information;
providing securing means on said paper;
depositing retackable glue on the paper; and
forming at least one fold line on said paper, said fold line dividing said form into at least two panels, a first panel and a second panel, said area being on at least one of said first and second panels, each of said first and second panels defined by said fold line, a distal edge generally parallel to said fold line and two generally parallel transverse edges extending between said fold line and said distal edge, said retackable glue on at least one of said first and second panels, located generally proximate to each of the generally parallel transverse edges, said securing means located generally proximate to at least one of the distal edges of the first and second panels, said form being foldable along the fold line to mate the first and second panels such that said retackable glue on at least one of said first and second panels mates with the other of said first and second panels and the sealing means acts to generally mate at least one of the distal edges with at least one of the first and second panels, thereby generally providing a bond between the first and second panels which generally secures the concealed information by providing that said information cannot generally be accessed without an appearance of the package providing proof of tampering.
